(19) United States
(12) Patent Application Publication
(10) Pub. No.: US 2013/0003380 A1
(43) Pub. Date: Jan. 3, 2013

(54) LIGHT TUBE HOLDER

(75) Inventors: QING-SHAN CAO, Shenzhen City (CN); JIAN-PU CHEN, Shenzhen City (CN); YU HU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/301,797

(22) Filed: Nov. 22, 2011

(30) Foreign Application Priority Data
Jun. 29, 2011 (CN) 201110178346.7

(51) Int. Cl. F21V 21/002

(52) U.S. Cl. 362/249.07

(57) ABSTRACT

A light tube holder includes a base and two connectors for receiving either a light-emitting diode (LED) tube or a fluorescent tube. The connector includes a rotary member rotatably received in a through hole defined in a retainer, and three conductive elastic pieces positioned in the retainer around the through hole. One elastic piece is electrically connected to an LED tube drive circuit board, and the other two elastic piece are electrically connected to a fluorescent tube drive circuit board. The rotary member can be rotated to first and second positions, wherein at the first position, the LED tube can be activated, and at the second position the fluorescent tube can be activated.

### CROSS-REFERENCES TO RELATED APPLICATIONS

Related subject matter is disclosed in co-pending U.S. patent applications with an Attorney Docket Number US39862 and a title of ILLUMINATION DEVICE, an Attorney Docket Number US39863 and a title of ILLUMINATION DEVICE, an Attorney Docket Number US39864 and a title of ILLUMINATION DEVICE, an Attorney Docket Number US39865 and a title of ILLUMINATION DEVICE, an Attorney Docket Number US39866 and a title of ILLUMINATION DEVICE, and an Attorney Docket Number US40306 and a title of ILLUMINATION DEVICE, which have the same assignees as the current application and were concurrently filed.

### BACKGROUND

1. Technical Field

The present disclosure relates to tube holders, and particularly, to a tube holder for adapting a light-emitting diode (LED) tube and a fluorescent tube.

2. Description of the Related Art

Generally, a conventional light tube holder for fluorescent tubes can not be used with LED tubes. When attempting to use an LED tube, the conventional light tube holder needs to be replaced. It is desirable and useful if a light tube holder can adapt to both fluorescent tubes and LED tubes.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an illuminating device in accordance with an exemplary embodiment.

FIG. 2 is an exploded view of the illuminating device in FIG. 1.

FIG. 3 is an exploded view of a connector of the illuminating device in FIG. 1.

FIG. 4 is an isometric view of a retainer of the connector of the illuminating device in FIG. 3 according to a first exemplary embodiment.

FIG. 5 is an isometric view of the retainer of the connector of the illuminating device in FIG. 3 according to a second exemplary embodiment.

FIG. 6 is an isometric view of the retainer of the connector of the illuminating device in FIG. 3 according to a third exemplary embodiment.

FIG. 7 is an isometric view of the retainer of the connector of the illuminating device in FIG. 3 according to a fourth exemplary embodiment.

### DETAILED DESCRIPTION

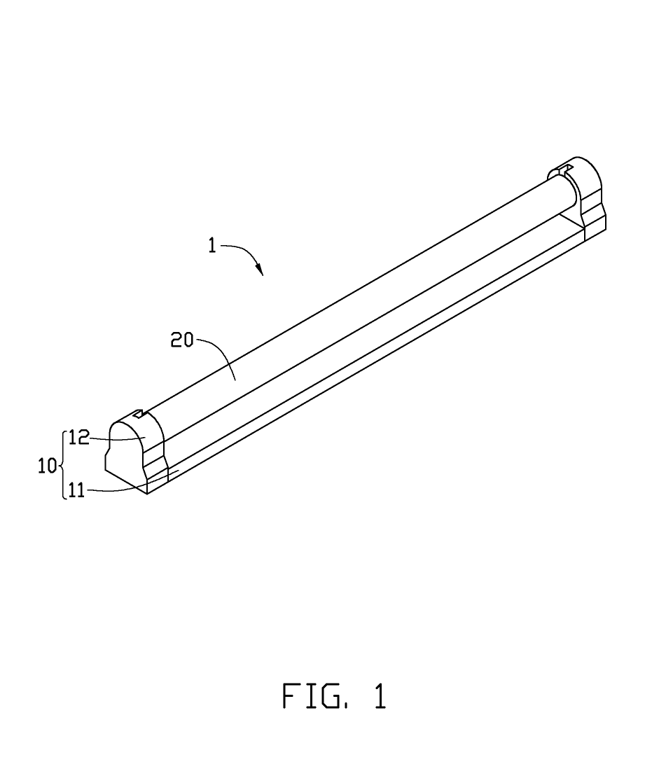

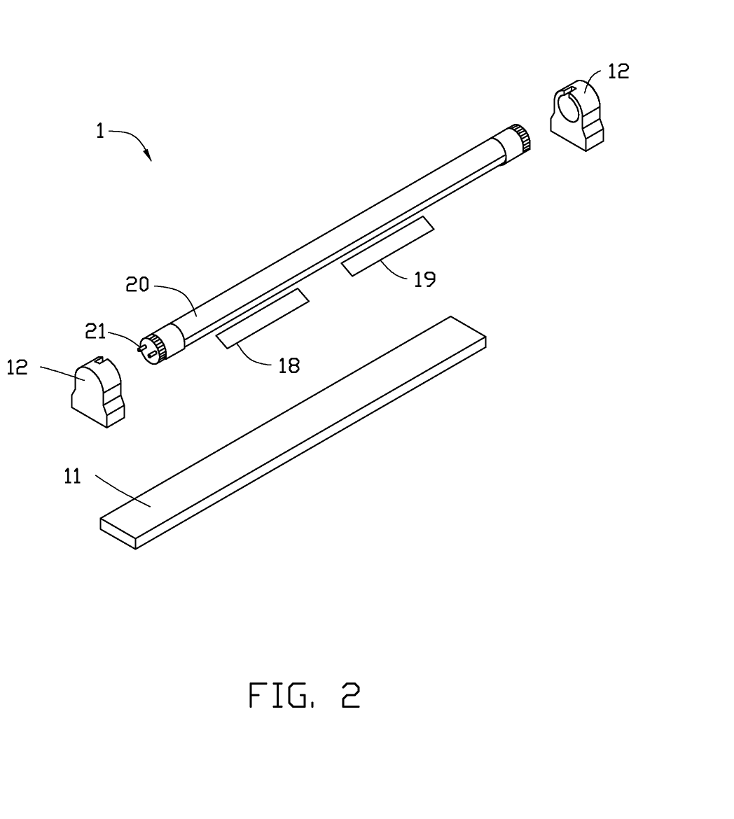

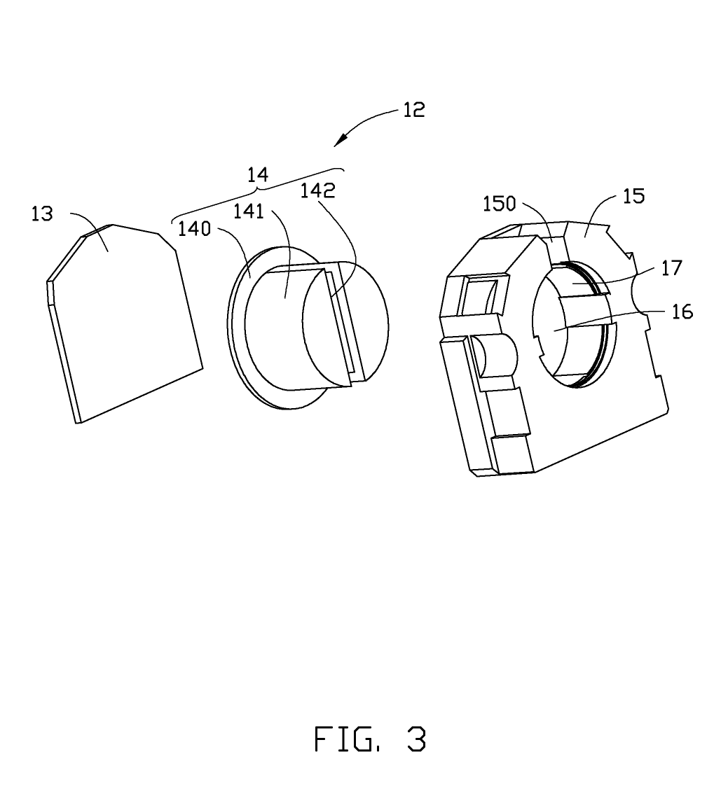

Referring to FIGS. 1-3, an illuminating device 1 includes a tube holder 10 and a tube 20 mounted on the tube holder 10. The tube 20 can be a traditional fluorescent tube or a light-emitting diode (LED) tube. The LED tube has two pins on one end thereof and two pins on an opposite end thereof. The fluorescent tube has two conductive pins on one end thereof and two conductive pins on an opposite end thereof. The tube holder 10 can adapt a tube 20 in the both types. The tube holder 10 includes a base 11 and two connectors 12 at opposite ends of the base 11. Each connector 12 includes a cap 13, a retainer 15, and a rotary member 14. The cap 13 is attached to one end of the retainer 15. The cap 13 and the retainer 15 cooperatively define a space to receive the rotary member 14 therein. In the embodiment, a through hole 16 is defined in the retainer 15. The rotary member 14 is smaller in diameter than the though hole 16, thereby allowing the rotary member 14 to be received and to rotate in the through hole 16. The rotary member 14 is in the shape of a hat, including a brim 140, a body 141, and a first groove 142. The brim 140 is larger in diameter than the though hole 16, and abuts the outside end face of the retainer 15 around though hole 16. The first groove 142 is diametrically defined in the body 141 and divides the body 141 into two substantially equal parts. The first groove 142 can receive the two pins 21 of the tube 20 therein. An opening 150 is defined in the retainer 15, on a line substantially perpendicular to, and furthest from, the base 11, and extends from an external lateral surface to the sidewall of the through hole 16, and communicates with the through hole 16.

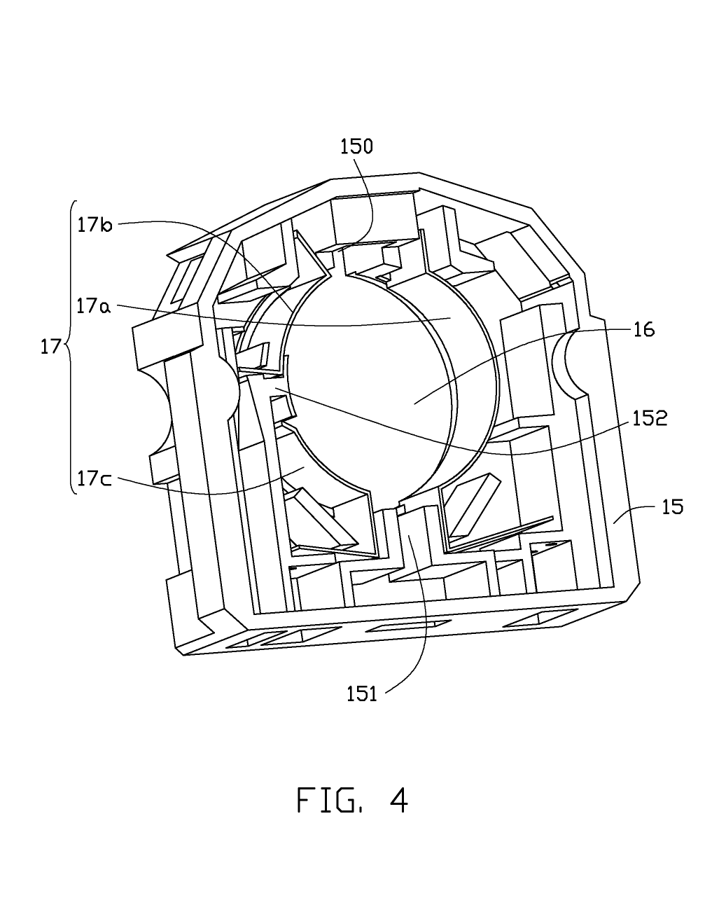

Referring to FIG. 4, an elastic member 17 consisting of three elastic pieces 17a, 17b, 17c is positioned in the retainer 15 around the through hole 16. Each elastic piece 17a, 17b, 17c is made of an elastic metal sheet by stamping. The elastic piece 17a has a configuration of a half of a circle, while each of the elastic pieces 17b, 17c has a configuration of one fourth of a circle. A second groove 151 is defined in the retainer 15 opposite the opening 150. In this embodiment, at least one buffer pad 152 is defined on the side wall between the opening 150 and the second groove 151. The opening 150, the second groove 151, and the at least one buffer pad 152 are used to separate the three elastic pieces 17a, 17b, 17c of the elastic member 17 from each other. The three elastic pieces 17a, 17b, 17c of the elastic member 17 can then be electrically insulated from each other. The tube holder 10 further includes an LED tube drive circuit board 18 and a fluorescent tube drive circuit board 19 mounted in the base 11. The elastic pieces 17a, 17b are connected to the LED tube drive circuit board 18 and the elastic pieces 17a, 17c are connected to the fluorescent tube drive circuit board 19.

When installing the tube 20, the rotary member 14 is firstly rotated to cause the first groove 142 to align with the opening 150. The pins 21 of the tube 20 can then be inserted into the through hole 16 and supported in the first groove 142. The tube 20 can then be rotated to misalign the first groove 142 of the rotary member 14 with the opening 150, and securely retain the tube 20 in the retainer 15.

When the tube 20 is rotated to a predetermined position (indicated by a mark (not shown) on the connector 12), the rotary member 14 is rotated to a first position where the pins 21 of the tube 20 make contact with the elastic pieces 17a, 17b of the elastic member 17. Thus, the tube 20 can be driven by the LED tube drive circuit board 18. At the first position, the tube 20 is an LED tube 20 and can be driven by the LED tube drive circuit board 18 to generate light. When the element 14 is rotated to a second position, the pins 21 of the tube 20 make contact with the elastic pieces 17a, 17c of the elastic member 17, allowing the tube 20 to be driven by the fluorescent tube drive circuit board 19. At the second position, the tube 20 is a fluorescent tube 20 and can be driven by the fluorescent tube drive circuit board 19 to generate light. By virtue of these arrangements, the tube holder 10 can well adapt to any type of the tube 20.

In the first embodiment, the elastic member 17 includes three elastic pieces 17a, 17b, and 17c. The length of the elastic piece 17a is about 0.5A, where A represents the perimeter of the through hole 16. The lengths of the elastic pieces 17b and 17c are both 0.25A. The number of the at least one buffer pad 152 is one. Thus, the elastic pieces 17a, 17b, and 17c are separated from each other by the opening 150, the second groove 151 and the buffer pad 152.

In an alternative embodiment, the elastic pieces 17a and 17b may be connected to the fluorescent tube drive circuit board 19, and the elastic pieces 17a and 17c may be connected to the LED tube drive circuit board 18.

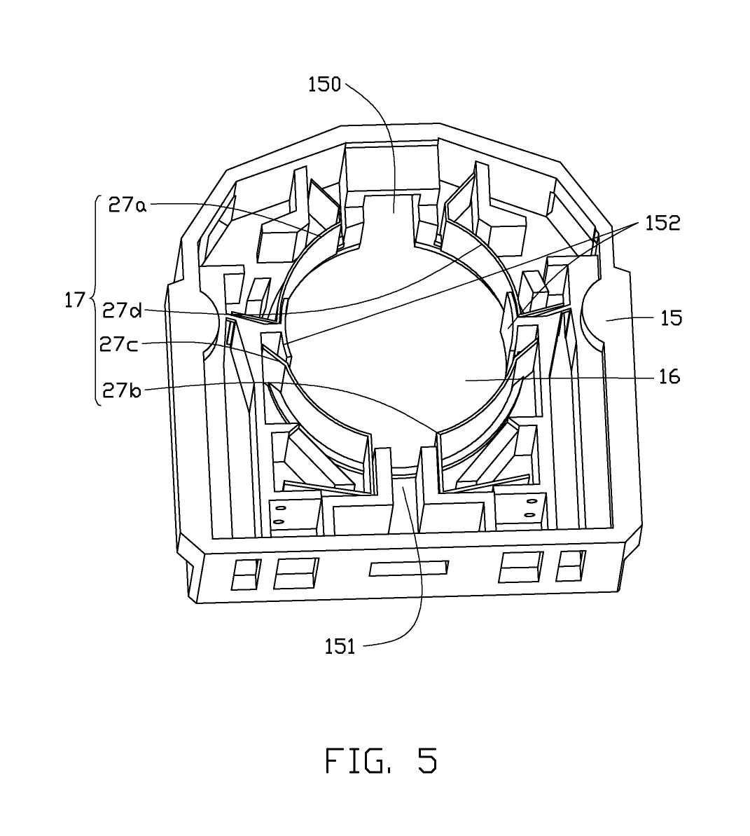

Referring to FIG. 5, in a second embodiment, there are four elastic pieces 27a, 27b, 27c, and 27d constituting the elastic member 17. The lengths of the four elastic pieces 27a, 27b, 27c, and 27d are all 0.25A. The number of the at least one buffer pad 152 is two. Thus, the elastic pieces 27a, 27b, 27c, and 27d are separated from each other by the opening 150, the second groove 151 and the two buffer pads 152.

In the embodiment, the elastic pieces 27a and 27b are connected to the LED tube drive circuit board 18, and the elastic pieces 27c and 27d are connected to the fluorescent tube drive circuit board 19. The first position mentioned above is the position where the pins 21 of the tube 20 stay in contact with the elastic pieces 27a and 27b, and the second position mentioned above is the position where the pins 21 of the tube 20 stay in contact with the elastic pieces 27c and 27d.

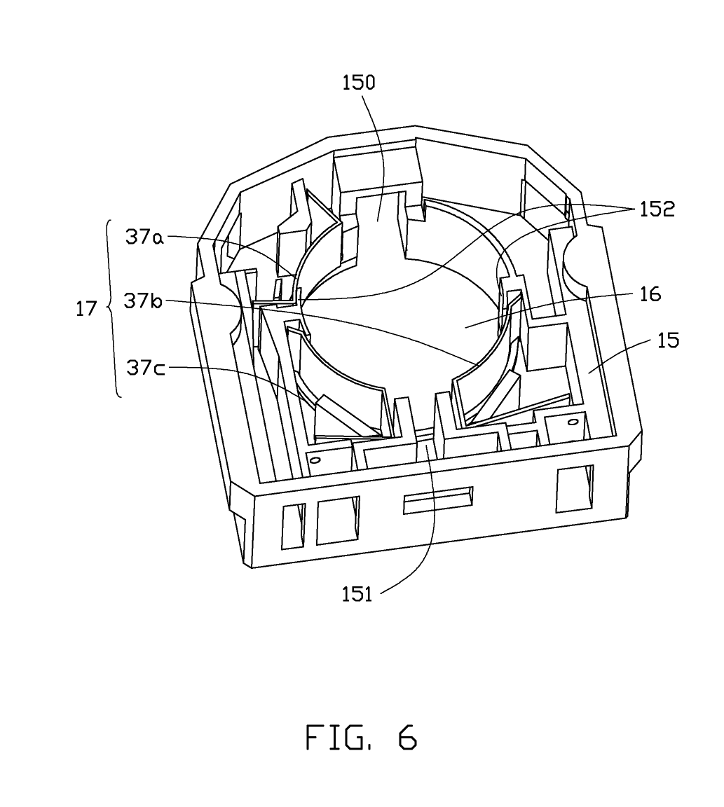

Referring to FIG. 6, in a third embodiment, there are three elastic pieces 37a, 37b and 37c constituting the elastic member 17. The lengths of the three elastic pieces 37a, 37b and 37c are all 0.25A. The number of the at least one buffer pad 152 is two. Thus, the elastic pieces 37a, 37b, and 37c are separated from each other by the opening 150, the second groove 151 and the two buffer pads 152.

In the embodiment, the elastic pieces 37a and 37b are connected to the fluorescent tube drive circuit board 19, and the elastic pieces 37c are connected to the LED tube drive circuit board 18. The first position mentioned above is the position where two of the pins 21 of the LED tube 20 which are conductive and located respectively at opposite ends of LED tube 20 stay in contact with the elastic pieces 37c while the other two of the pins 21 which are insulating and located respectively at the opposite ends of the LED tube 20 do not contact anything, and the second position mentioned above is the position where the pins 21 of the fluorescent tube 20 stay in contact with the elastic pieces 37a and 37b.

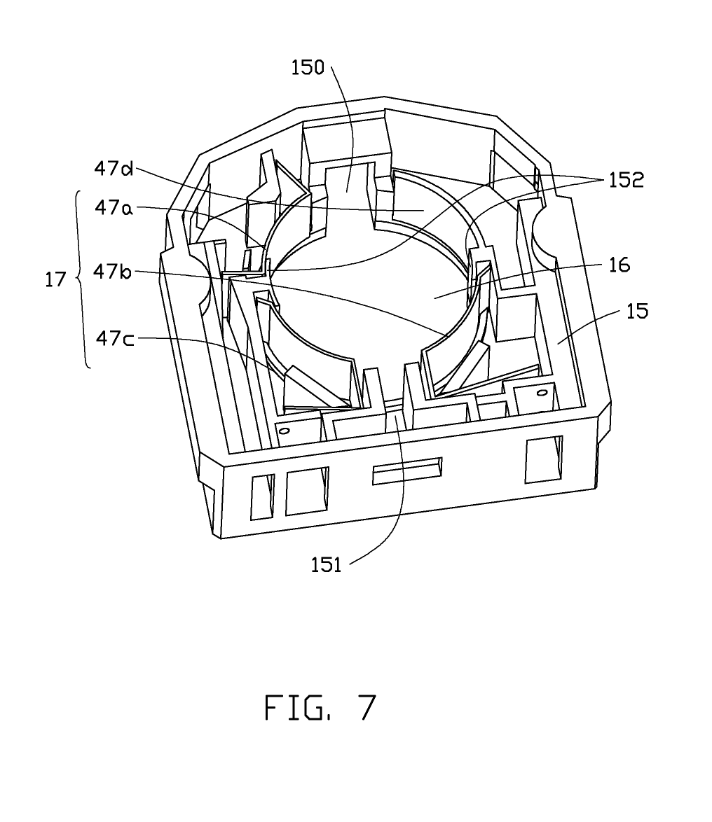

Referring to FIG. 7, in a fourth embodiment, there are three elastic pieces 47a, 47b, and 47c constituting the elastic member 17. The lengths of the three elastic pieces 47a, 47d, and 47c are all 0.25A. An insulation piece 47d is positioned in the retainer 15 around the through hole 16 with the elastic pieces 47a, 47b, and 47c. The insulation piece 47d is resilient, and has a configuration of one fourth of a circle. The length of the insulation piece 47d is about 0.25A. The number of the at least one buffer pad 152 is two. Thus, the elastic pieces 47a, 47b, 47c, and the insulation piece 47d are separated from each other by the opening 150, the second groove 151 and the two buffer pads 152. The elastic pieces 47a, 47b of the two connectors 12 are connected to the fluorescent tube drive circuit board 19 and the elastic pieces 47c are connected to the LED drive circuit board 18.

When installing the tube 20, the rotary member 14 is rotated to a position where the pins 21 of the tube 20 stay in contact with the elastic piece 47c and the insulation piece 47d, the elastic piece 47c and the insulation piece 47d can tightly press against the two pins 21 of the tube 20, thereby holding the tube 20 in position.

In the embodiment, the elastic pieces 47a and 47b are connected to the fluorescent tube drive circuit board 19, and the elastic piece 47c is connected to the LED tube drive circuit board 18. The first position mentioned above is the position where two of the pins 21 of the LED tube 20 which are conductive and located respectively on two opposite ends thereof stay in contact with the elastic pieces 47c while the other two of the pins 21 which are insulating and located respectively at the opposite ends of the LED tube 20 stay in contact with the insulation pieces 47d, and the second position mentioned above is the position where the pins 21 of the fluorescent tube 20 stay in contact with the elastic pieces 47a and 47b.

The LED tube used in the embodiments of FIGS. 4 and 5 is an LED tube with two insulating pins on one end thereof and two conductive pins on an opposite end thereof. LEDs in the LED tube are serially connected between the two conductive pins at one end of the LED tube. The LED tube used in the embodiments of FIGS. 6 and 7 is an LED tube with an insulating pin and a conductive pin on each of two opposite ends of the LED tube. LEDs received in the tube are serially connected between the two conductive pins at the two opposite ends of the LED tube.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A light tube holder comprising:
a base;
a light-emitting diode (LED) tube drive circuit board mounted in the base;
a fluorescent tube drive circuit board mounted in the base;
a pair of connectors arranged at opposite ends of the base for selectively receiving one of a fluorescent tube and an LED tube, the fluorescent tube and the LED tube both comprising two pins arranged on one end thereof and another two pins arranged on an opposite end thereof;
wherein each of the pair of connectors comprises:
a retainer defining a though hole;
a rotary member rotatably received in the through hole, and defining a first groove to receive the two pins on one end of one of the tubes; and
at least three elastic pieces positioned in the retainer around the through hole, and respectively connected to the LED tube drive circuit board and the fluorescent tube drive circuit board;
wherein when the rotary members of the pair of the connectors are rotated to a first position, at least one of the two pins on the one end of one of the tubes stay in contact with the elastic pieces connected to the LED tube drive circuit board, and allowing the tube to be driven by the LED tube drive circuit board when the tube is the LED tube; and
when the rotary members of the pair of the connectors are rotated to a second position, the two pins on the one end of one of the tubes stay in contact with the elastic piece connected to the fluorescent tube drive circuit board, and allowing the tube to be driven by the fluorescent tube drive circuit board when the tube is the fluorescent tube.

2. The tube holder as recited in claim 1, wherein the each of the at least three elastic pieces has an arced configuration.

3. The tube holder as recited in claim 1, wherein the pair of connectors comprise a first connector and a second connector and an opening is defined in the retainer of the first connector and extends from an external lateral surface to a sidewall thereof surrounding the through hole, and communicates with the through hole.

4. The tube holder as recited in claim 3, wherein the first connector further comprising:
a second groove defined in the retainer thereof opposite the opening; and
at least one buffer pad formed on the side wall, between the opening and the second groove, the opening, the second groove, and the at least one buffer pad separate the at least three elastic pieces from each other.

5. The tube holder device as recited in claim 4, wherein the at least three elastic pieces comprising at least one first elastic piece, a second elastic piece and a third elastic piece, a length of the at least one first elastic is about half of a perimeter of the through hole, and lengths of the second and third elastic pieces are both about a quarter of the perimeter of the through hole; the number of the at least one buffer pad is one; the at least one first elastic piece, the second elastic piece, and the third elastic piece are separated from each other by the opening, the second groove and the buffer pad.

6. The tube holder device as recited in claim 5, wherein the at least one first elastic piece comprises two first elastic pieces, lengths of the two first elastic pieces, the second elastic piece, the third elastic pieces are all a quarter of the perimeter of the through hole; the at least one buffer pad comprises a first buffer pad and a second buffer pad; the two first elastic pieces, the second elastic piece and the third elastic piece are separated from each other by the opening, the second groove, the first buffer pad, and the second buffer pad, one of the first elastic pieces being electrically connected to the LED tube drive circuit board and the other one of the first elastic pieces being electrically to the fluorescent drive circuit board.

7. The tube holder as recited in claim 5, wherein lengths of the at least one first, second and third elastic pieces are both about a quarter of the perimeter of the through hole; the at least one buffer pad comprises a first buffer pad and a second buffer pad; the at least one first elastic piece, the second elastic piece, and the third elastic piece are separated from each other by the opening, the second groove and the first buffer pad and the second buffer pad.

8. The tube holder as recited in claim 7, wherein an insulation piece is positioned in the retainer around the through hole, the insulation piece is resilient and has a configuration of a quarter of a circle.

9. The tube holder as recited in claim 8, wherein when the rotary member is rotated to a position where the pins of the tube stay in contact with the third elastic piece and the insulation piece, the third elastic piece and the insulation piece tightly press against the two pins of the tube to hold the tube in position.

10. The tube holder as recited in claim 9, wherein the LED tube has a conductive pin and an insulating pin at each two opposite ends of the LED tube.

11. The tube holder as recited in claim 6, wherein the LED tube has two conductive pins at an end thereof, and two insulating pins at an opposite end thereof.

12. The tube holder as recited in claim 1, wherein the LED tube has a conductive pin and an insulating pin at each two opposite ends of the LED tube.

13. The tube holder as recited in claim 1, wherein the LED tube has two conductive pins at an end thereof, and two insulating pins at an opposite end thereof.
